(19) United States
(12) Patent Application Publication
(10) Pub. No.: US 2006/0293038 A1
(43) Pub. Date: Dec. 28, 2006

(54) Home cellular system

(75) Inventors: Edward Walter, Boerne, TX (US); Yolius Diroo, San Antonio, TX (US); Steven M. Wollmershauser, San Antonio, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/159,756

(22) Filed: Jun. 23, 2005

(51) Int. Cl. H04M 3/00

(52) U.S. Cl. 455/418

(57) ABSTRACT

The present invention discloses a method and apparatus for receiving a plurality of cellular telephone signals over an RF communication system. The present invention receives at least one signal at a cellular frequency, identifies a user associated with the cellular signal, converts the signal to an RF signal, and sends the converted RF signal to the RF communication system. The call is received at wireless RF handset. A removable Subscriber Identity Module (SIM) of a cell phone docked and integrated with the present invention to route the cellular call to RF receiver. Multiple RF communication lines are managed. Various methods of notifying the intended recipient are disclosed, such as textual display and distinctive ring tones.

### BACKGROUND OF THE INVENTION

1. Field of the Invention

The present invention relates to the field of wireless communication. In particular, the present invention provides an apparatus and method for transferring a call over a cellular frequency to an intended recipient over a radio frequency.

2. Description of the Related Art

Generally, there is a clear delineation between a wireless phone user (such as a cellular phone user) and a wired phone user (such as a user of a typical landline phone connection). The wireless user purchases a wireless phone and service through an established wireless provider. All features and functions are provided by the wireless phone or the wireless service provider. The same applies to the wired phone user. The telephony user purchases an access line from the local provider—either an Incumbent Local Exchange Carrier (ILEC) or a Competitive Local Exchange Carrier (CLEC)—and plugs in a phone that utilizes the existing local loop and existing network infrastructure of the carrier.

Cellular coverage is typically provided by GSM/CDMA (Global System for Mobile telecommunications/Code Division Multiple Access). CDMA is a digital air interface standard based on spread spectrum technology, which means that it spreads the information contained in a particular signal over a much greater bandwidth than the original signal. GSM is a globally accepted standard for digital cellular communication.

One of the key features of GSM is the use of a Subscriber Identity Module (SIM), commonly known as a SIM card. The SIM is a detachable smartcard containing the user's subscription information and phonebook. Information on the SIM enables the cellular signal to be sent to the appropriate handset (i.e. wireless phone). Using the SIM card enables the user to retain his information upon switching handsets. Alternatively, the user can change operators while retaining the handset simply by changing the SIM.

New developments are emerging in which a dual mode mobile phone using both 802.11 and GSM/CDMA reside on the same handset. IEEE 802.11 or Wi-Fi denotes a set of Wireless LAN standards developed by Working Group 11 of the IEEE LAN/MAN Standards Committee (IEEE 802). The term is also used to refer to the original 802.11, which is now sometimes called “802.11 legacy.” The 802.11 family currently includes six over-the-air modulation techniques that all use the same protocol, the most popular (and prolific) techniques are those defined by the a, b, and g amendments to the original standard. 802.11b and 802.11g standards use the unlicensed 2.4 gigahertz (GHz) band. The 802.11a standard uses the 5 GHz band. Operating in an unregulated frequency band, 802.11b and 802.11g equipment can incur interference from microwave ovens, cordless phones, and other appliances using the same 2.4 GHz band. However, using the existing wireless protocols that the cellular carrier uses enables operating with existing handsets with no modification required.

There has been very limited mixing of wireless and wired phone services, except when bundling the billing option. One example of mixing wireless and wired services is “Fast Forward” from SBC. In “Fast Forward,” the user docks a wireless phone, typically in a cradle designed to hold the wireless phone. When the wireless phone is “cradled,” calls to the wireless phone are forwarded to a designated landline phone. Calls that would have gone to the wireless phone instead ring the designated landline telephone. Cellular phone use has grown in popularity, such that some people no longer use their residential landline phone connection.

### SUMMARY OF THE INVENTION

The present invention discloses a method and apparatus for receiving a plurality of cellular telephone signals over an RF communication system. A wireless apparatus, referred to herein as a home base station, leverages an existing cellular provider and the RF communication system to receive a plurality of call signals at a residence. The home base station receives one of the plurality of cellular signals, and identifies a user (e.g., a cellular phone customer) associated with the cellular signal. The home base station converts the received cellular signal to an RF signal, and sends the RF signal to the communication system. The user then receives the signal by picking up an RF handset in communication with the home base station. Sending the RF signal includes identifying the caller by identifying a Subscriber Identity Module (SIM) docked at the home base station. The home base station comprises one or more slots for receiving at least one removable SIM of a cell phone. The SIM generally provides information identifying the cell phone so that a cellular signal can be routed to the intended recipient. To use the present invention, the user typically removes the SIM or SIM like device from the cell phone and inserts the SIM into one of the slots of the home base station. Information from the SIM is read into a temporary memory. This information can then be referenced to receive an incoming cellular signal at the home base station, perform cellular-to-RF conversion, and route the signal to the appropriate RF receiver.

Multiple RF receivers are generally used in connection with the home base station. Incoming signals can be transferred to an available RF receiver to avert the possibility of busy lines. The user can be notified of an incoming cellular signal (incoming call) using various methods. In one method, a recognizable audio signal is used to distinguish the intended recipient of the call. In another method, textual information can be displayed on a visual screen, such as is commonly provided on a receiver handset.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 illustrates a cell tower providing cellular communication to a surrounding neighborhood;

FIG. 2 illustrates an exemplary embodiment of the present invention in communication with various RF receivers;

FIG. 3 illustrates a high-level wiring diagram of an exemplary embodiment of the present invention; and

FIG. 4 illustrates a flowchart of one aspect of the present invention.

### DETAILED DESCRIPTION OF THE INVENTION

In view of the above, the present invention through one or more of its various aspects and/or embodiments is presented to provide one or more advantages, such as those noted below.

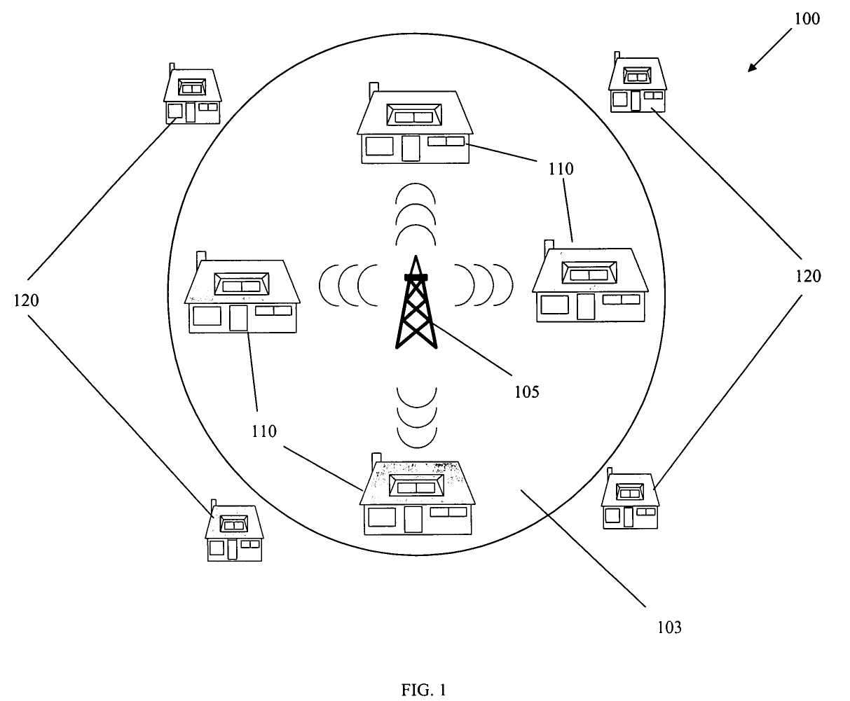

FIG. 1 illustrates a cell tower providing cellular communication to a surrounding neighborhood 100. Cell tower 105 provides cellular communication throughout cell 103 and is typically connected to a cellular communications network. The cell 103 is defined by the range of radio contact that the cell tower can reach. Residences 110 which are located within the cell 103 are generally able to communicate with the cell tower. Residences 120 which lie outside cell 103 are generally unable to communicate with the cell tower. As the present invention operates over cellular communication frequencies, those residences 110 that fall within a cell 103 are suitable for use with the invention.

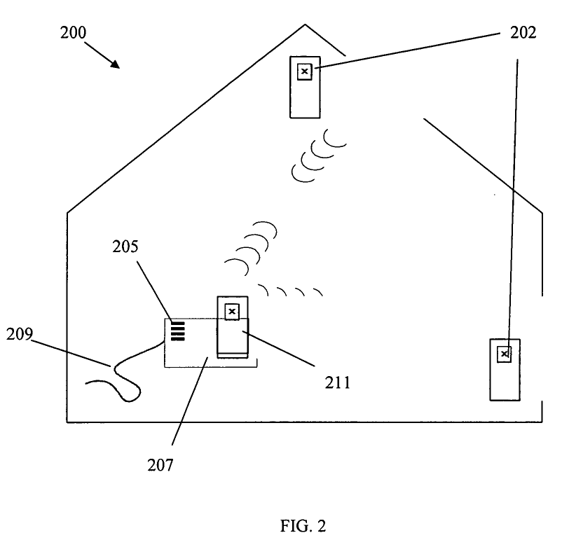

FIG. 2 illustrates a home cellular system for receiving a plurality of cellular signals over an RF communication system, also referred to herein as RF handsets. The present invention generally provides coverage to RF receivers 202 of residence 200. The present invention enables a cellular user to dock their cellular phone SIM in a self-contained wireless base station 207. Multiple cellular phone SIMs can be “docked”. The home base station is also equipped with a permanent embedded chip, so as to be cellular-ready and so that home phone calls to the base station can be received while a user is away from the home with their cellular phone.

The cellular signal is the “trunk” mechanism that brings the phone call into the residence. The home base station 207 receives the cellular signal (generally a GSM/CDMA signal), converts the cellular signal into RF for transmission to the RF handsets, and communicates the converted RF signal to wireless RF handsets 202 (commonly operating at 900 MHz or 2.4 GHz). The base station can be powered through plugging into a wall outlet 209. The base station provides a cradle for docking a portable handset 211. Slots 205 are available for docking one or more SIMs.

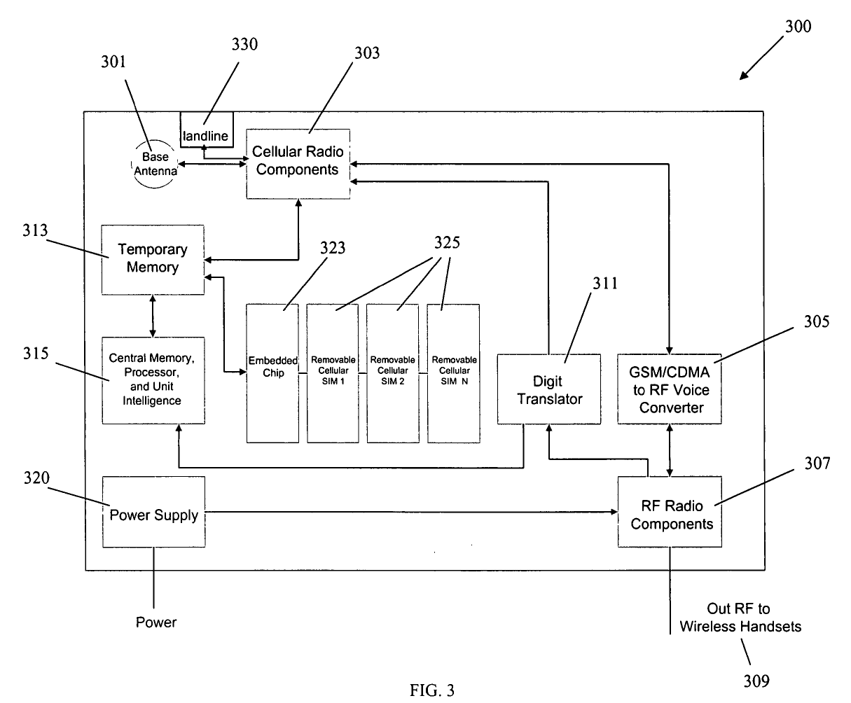

FIG. 3 illustrates a high-level wiring diagram of an exemplary home base station 300 of the present invention. The system comprises a permanent embedded chip 323 as well as slots 325 for receiving removable SIMs associated with cellular phones. The permanent embedded chip 323 enables cellular calls to be received just as in a permanent residential phone line. Additionally, a landline connection 330 can be made. In one aspect of the present invention, the wireless user removes the SIM from an unlocked cellular phone and docks it in one of the slots 325. Upon docking the SIM, information stored on the SIM is copied into a temporary memory 313. Multiple SIM chip information can be stored at the temporary memory 313. The home base station receives calls for each docked SIM. When multiple SIM cards are docked, the home base station receives multiple calls, each of which can be associated with a different SIM. The base station sends the signals to the RF handsets. Identification information of the incoming cellular call is checked against data stored in temporary memory 313, and RF routes are subsequently configured. To enable routing through the home base station, the SIM is registered with the present invention at the cellular service provider upon docking the SIM in a slot 325. The service provider then sends cellular signals to the SIM in the home base station 300 rather than to the cellular phone. The central processor 315 enables checking SIM information in temporary storage and at SIM docking stations to identify intended recipients, as well as providing further telephony features. As an example, these telephony features include those options that can be activated by the “*” and “#”, such as by pressing “*69” for call return or pressing the “#” button to indicate the end of an input, for instance of a credit card number. Power is provided by power supply 320.

For communications operation, the Cellular CDMA/GSM cellular components 303 transmit and receive cellular signals to and from the cellular network via base antenna 301. The CDMA/GSM radio components 303 comprises circuitry to enable communication within a cellular frequency range, i.e. with a cell tower. Incoming cellular signals pass from base antenna 301 through the cellular CDMA/GSM radio components 303, Gateway Conversion component 305, and RF radio components 307 to be transmitted to portable RF handsets 309. The Gateway Conversion component 305 converts between CDMA/GSM signals and RF signals. The RF radio components 307 comprises circuitry to enable communication within a RF range with RF receivers. The communications pathway is bidirectional, enabling transmitting RF signals to the cellular network as well as cellular network signals to be transmitted to the RF handsets. A digit translator component 311 enables transfer of touchtone signal information between RF and cellular circuitry. Multiple operating radio frequencies are available for communication between the home base station 207 and the RF handsets 202. Each SIM can simultaneously receive an incoming cellular call at the home base station. The home base station retransmits each incoming cellular call to all or a specifically identified RF handset 202 over a different radio frequency. Thus the single line at a residence is converted to multiple lines by the home base station.

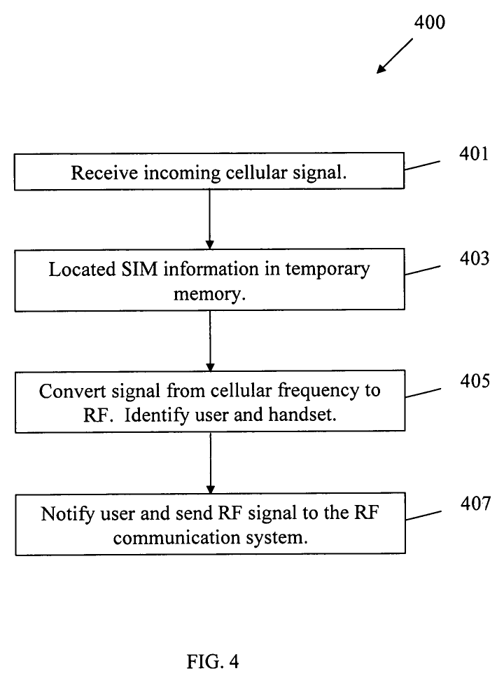

FIG. 4 illustrates a flowchart 400 of one aspect of the present invention. In Box 401, an incoming cellular signal is received at the home base station. The SIM information pertaining to the call is located at its place in temporary memory in Box 403. Locating the SIM information enables delivery of the signal to its intended recipient. In Box 405, the signal is converted from a cellular frequency signal to an RF signal. In Box 407, the converted RF signal is sent to the RF communication system.

One enhanced feature of the present invention is the ability to notify an intended recipient of an incoming call based upon which SIM is accessed. The present invention can leverage a visual display that is available at the RF handsets to provide a textual message. Additionally, a textual message can be shown on a visual display integrated into the base station. Alternatively, a textual message can be displayed on a monitor or television screen. In an additional aspect, distinctive rings can be chosen for each user so that the type of ring indicates for whom the call is intended.

Another enhanced feature of the present invention is the ability to provide multi-line capabilities to the communication link. A landline for typical Public Switched Telephone Network (PSTN) or Voice over Internet Protocol (VoIP) services at the residence can also be provided. The landline rings all phones at the same time. A landline, if any, is designated as “Line 1”. The permanent embedded chip is generally designated as “Line 2,” and as each SIM is slotted, each additional line is enabled and designated as line 3, 4, 5, etc. Thus, multiple users can initiate calls and/or receive calls simultaneously.

Another enhanced feature of the present invention (related to the multi-line capability) is a line rollover function in which a second communication channel for one docked SIM can be established even if a SIM is currently in use. When multiple SIMs are slotted, any user can pick up any available RF phone to take a call. A conflict can occur when an inbound call is designated for a SIM card that is already in use (Busy Line). To avoid this conflict, the phone or phones in use are detected and rolled out; that is, phones that are not in use are able to receive the call. If the inbound call is intended for a user other than the user busy on a line, then the available phones ring, while the line in use does not receive a signal indicating an incoming call. However, if the inbound call is intended for a user that is already talking on another line, then the available phones ring, and the phone that is in use by the user for whom the inbound call is intended gets a call waiting indication. In the event that an inbound call is attempting to complete on a busy line, the call rolls over, via the wireless service provider, to one of the other docked SIMs, thereby enabling the call to be answered by the appropriate party on another RF handset. This line rollover is enabled due to registration of docked SIMs with the wireless service provider. Additionally, if after a designated number of rings, the call is not picked up, then the inbound caller can be routed to a voicemail function assigned to that SIM.

Yet another enhanced feature of the present invention is a “message waiting” indicator. Each docked SIM can be assigned a light that flashes when messages are waiting for that SIM/user. In addition, the visual display on the RF phone can display which users have messages and the number of message waiting for each.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for receiving a plurality of cellular telephone signals over a radio frequency (RF) communication system, comprising:
receiving one of the plurality of cellular telephone signals;
identifying a user associated with the received cellular telephone signal;
converting the received cellular signal to an RF signal; and
sending the converted RF signal to the RF communication system.

2. The method of claim 1, wherein identifying the user further comprises referencing a Subscriber Identity Module (SIM) of the user.

3. The method of claim 2, wherein the SIM is transferable from a cellular transceiver device.

4. The method of claim 1, wherein sending the converted RF signal further comprises identifying an RF handset from a plurality of RF handsets in the RF communication system and sending the RF signal to the identified handset.

5. The method of claim 4, wherein sending the converted RF signal further comprises rolling over an RF signal to RF handsets available for receiving a call.

6. The method of claim 5, wherein sending the converted RF signal further comprises notifying the user of the presence of the converted RF signal.

7. The method of claim 6, wherein notifying the user further comprises providing a distinctive audio signal as a ring tone on the RF handsets available for receiving the call.

8. The method of claim 6, wherein notifying the user further comprises providing a call waiting signal on the identified handset.

9. An apparatus for receiving a plurality of cellular telephone signals over a radio frequency (RF) communication system, comprising:
a first antenna attuned to a cellular frequency range for receiving one of the plurality of cellular telephone signals;
a processor for identifying a user associated with the received cellular telephone signal;
a converter for converting the received cellular signal to an RF signal; and
a second antenna attuned to a radio frequency range for sending the converted RF signal to the RF communication system.

10. The apparatus of claim 9, further comprising one or more slots for docking a Subscriber Identity Module (SIM), the SIM usable in identifying the user.

11. The apparatus of claim 10, wherein the SIM is transferable from a cellular transceiver device.

12. The apparatus of claim 9, wherein sending the converted RF signal further comprises identifying an RF handset from a plurality of RF handsets in the RF communication system and sending the RF signal to the identified handset.

13. The apparatus of claim 12, wherein sending the converted RF signal further comprises rolling over an RF signal to RF handsets available for receiving a call.

14. The apparatus of claim 13, wherein sending the converted RF signal further comprises notifying the user of the presence of the converted RF signal.

15. The apparatus of claim 14, wherein notifying the user further comprises providing a distinctive audio signal as a ring tone (based on the SIM receiving the call) on the RF handsets available for receiving the call.

16. The apparatus of claim 14, wherein notifying the user further comprises providing a call waiting signal on the identified handset.

17. A computer readable medium containing instructions that when executed by a computer perform a method for receiving a plurality of cellular telephone signals over a radio frequency (RF) communication system, comprising:
receiving one of the plurality of cellular telephone signals;
identifying a user associated with the received cellular telephone signal;
converting the received cellular signal to an RF signal; and
sending the converted RF signal to the RF communication system.

18. The medium of claim 17, wherein in the method identifying the user further comprises referencing a Subscriber Identity Module (SIM) of the user.

19. The medium of claim 18, wherein in the method the SIM is transferable from a cellular transceiver device.

20. The medium of claim 17, wherein in the method sending the converted RF signal further comprises identifying an RF handset from a plurality of RF handsets in the RF communication system and sending the RF signal to the identified handset.

21. The medium of claim 17, wherein in the method sending the converted RF signal further comprises rolling over an RF signal to RF handsets available for receiving a call.

22. The medium of claim 21, wherein in the method sending the converted RF signal further comprises notifying the user of the presence of the converted RF signal.

23. The medium of claim 22, wherein in the method notifying the user further comprises providing a distinctive audio signal as a ring tone on the RF handsets available for receiving the call.

24. The medium of claim 22, wherein in the method notifying the user further comprises providing a call waiting signal on the identified handset.
